(19) United States
(12) Patent Application Publication
(10) Pub. No.: US 2017/0292626 A1
(43) Pub. Date: Oct. 12, 2017

(54) VALVE DEVICE

(71) Applicant: Fujikin Incorporated, Osaka-shi (JP)

(72) Inventors: Zhaohong Zhang, Osaka-shi (JP); Takahiro Matsuda, Osaka-shi (JP)

(21) Appl. No.: 15/632,165

(22) Filed: Jun. 23, 2017

Related U.S. Application Data
(63) Continuation of application No. PCT/JP2015/080106, filed on Oct. 26, 2015.

(30) Foreign Application Priority Data
Dec. 26, 2014 (JP) 2014-265531

(51) Int. Cl. F16K 31/163; F16K 31/12; F16K 27/04

(52) U.S. Cl. CPC F16K 31/163; F16K 27/041; F16K 31/12; F16K 11/00

(57) ABSTRACT

A valve device includes a body having a fluid passage formed therein, a valve element configured to open and close the fluid passage, a stem arranged to be configured to move toward and away from the valve element to cause the valve element to open and close the fluid passage, an actuator having a casing coupled to the body, and drive unit arranged in the casing to drive the stem by an operating fluid supplied from outside, and a valve mechanism provided at the casing and configured to open and close a passage of the operating fluid to the drive unit.

### CROSS REFERENCE TO RELATED APPLICATION

This application is a continuation application of International Application No. PCT/JP2015/80106, filed Oct. 26, 2015, which claims priority to Japanese Patent Application No. 2014-265531, filed Dec. 26, 2014. The contents of these applications are incorporated herein by reference in their entirety.

### FIELD OF THE INVENTION

This invention relates to a valve device used in a fluid passage of a semiconductor manufacturing apparatus or the like.

### BACKGROUND OF THE INVENTION

An air-driven valve device in which a pipe joint is mounted on a valve main body and an operating fluid is introduced into the valve main body through the pipe joint, to thereby open the valve device to cause gas to flow, is disclosed in Japanese Patent Application Publication No. 2014-9765.

### SUMMARY OF THE INVENTION

However, when the operating fluid is erroneously supplied to the above-mentioned valve device, the valve device opens and gas is supplied to a semiconductor manufacturing apparatus or the like. As a result, gas is unintentionally supplied to the semiconductor manufacturing apparatus or the like.

Therefore, an object of the present invention is to provide a valve device which does not open even if an operating fluid is erroneously supplied and which can prevent gas from being unintentionally supplied to a semiconductor manufacturing apparatus or the like.

In order to attain the above object, a valve device according to one embodiment of the present invention includes: a body having a fluid passage formed therein; a valve element configured to open and close the fluid passage; a stem arranged to be configured to move toward and away from the valve element to cause the valve element to open and close the fluid passage; an actuator having a casing coupled to the body and a drive unit arranged in the casing to drive the stem by an operating fluid supplied from outside; and a valve mechanism provided at the casing and configured to open and close a passage of the operating fluid to the drive unit.

### BRIEF DESCRIPTION OF THE DRAWINGS

In the drawings:

FIG. 1 is a longitudinal sectional view of a valve device that is closed according to an embodiment of this invention.

FIG. 2 is an enlarged view of a vicinity of a knock-type valve mechanism that is closed.

FIGS. 3A to 3C are explanatory diagrams of a first guiding portion.

FIGS. 4A and 4B are explanatory diagrams of a knock portion.

FIG. 5 is a perspective view of a rotator.

FIGS. 6A(i) to 6A(v) and FIGS. 6B(i) to 6B(v) illustrate transition of operation of the knock-type valve mechanism.

FIG. 7 is a longitudinal sectional view of the valve device that is open according to an embodiment of this invention.

### DESCRIPTION OF THE EMBODIMENT

A valve device according to one embodiment of the present invention is described with reference to the drawings.

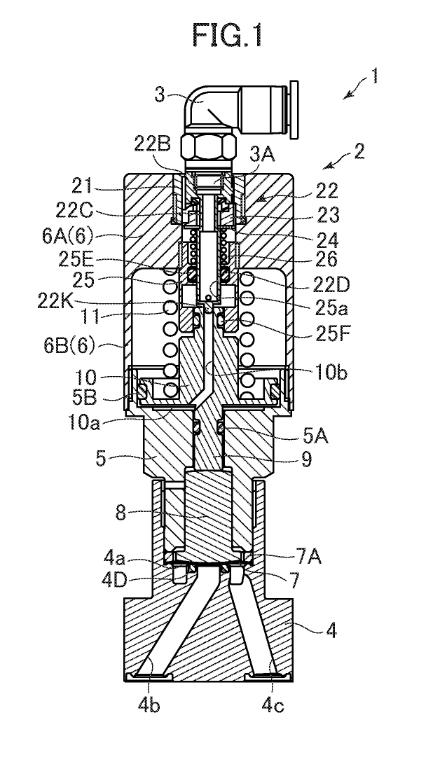

FIG. 1 is a longitudinal sectional view of a valve device that is closed according to a first embodiment. The valve device 1 illustrated in FIG. 1 is a diaphragm valve. The valve device 1 according to this embodiment is mainly a valve device used by being arranged on the uppermost stream side of each line in a gas supply apparatus (gas box) configured to supply various kinds of gas.

As illustrated in FIG. 1, the valve device 1 includes a valve main body 2 and a pipe joint 3. The valve main body 2 mainly includes a body 4, a bonnet 5, a cap 6, a diaphragm 7, a diaphragm pressing member 8, a stem 9, a piston 10, a first compression coil spring 11, and a knock-type valve mechanism 20. In the description below, the pipe joint 3 side of the valve device 1 is described as the upper side, and the body 4 side of the valve device 1 is described as the lower side.

The body 4 has a valve chamber 4a, and a fluid inflow passage 4b and a fluid outflow passage 4c communicating to the valve chamber 4a formed therein. A ring-shaped sheet 4D is arranged on the circumference of a section in which the fluid inflow passage 4b of the body 4 and the valve chamber 4a are brought to communication with each other.

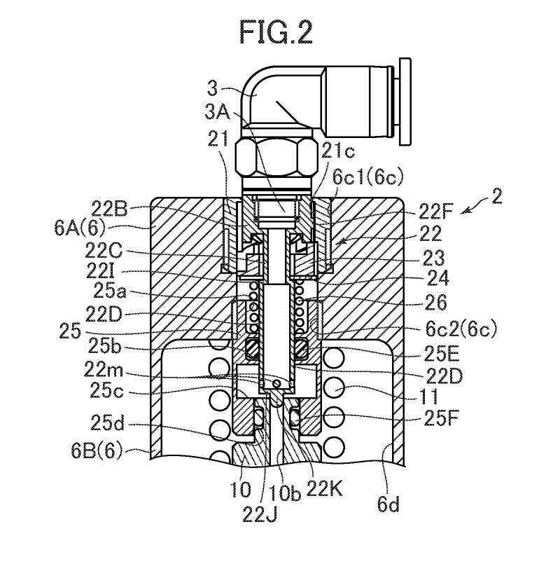

The bonnet 5 has a substantially cylindrical shape. By screwing a male screw portion arranged on the outer circumference of the lower end portion of the bonnet 5 in a female screw portion arranged in the valve body 4, the bonnet 5 is fixed to the valve body 4 so as to cover the valve chamber 4a. The cap 6 has a substantially cylindrical shape, and is fixed to the bonnet 5 by screwing a male screw portion arranged on the outer circumference of the lower end portion of the cap 6 in a female screw portion arranged in the upper end portion of the bonnet 5. The cap 6 has an upper portion 6A and a lower portion 6B. As shown in FIG. 2, the upper portion 6A has a mounting hole 6c formed therein, and the lower portion 6B has an accommodating hole 6d having an inner diameter larger than the inner diameter of the mounting hole 6c formed therein. The mounting hole 6c includes a first screw hole 6c1 and a second screw hole 6c2. The valve mechanism 20 is mounted in the mounting hole 6c. Hence, the valve mechanism 20 is provided at a casing including the bonnet 5 and the cap 6. As shown in FIG. 1, the lower portion 6B of the cap 6 and the upper end portion of the bonnet 5 are screwed together, thereby defining a space for accommodating the piston 10 and the first compression coil spring 11. The bonnet 5 and the cap 6 correspond to a casing of an actuator.

The diaphragm 7 serving as a valve element has an outer circumference portion thereof compressed and held by a pressing adapter 7A arranged on the lower end of the bonnet 5, and a bottom surface forming the valve chamber 4a of the body 4. The diaphragm 7 has a spherical shell shape, and the natural state thereof is an arc-like shape that is convex upward. The fluid passage is opened and closed by bringing the diaphragm 7 into abutment with the sheet 4D and moving away the diaphragm 7 therefrom. The diaphragm 7 is made of a thin plate of nickel alloy, for example, and is formed as a spherical shell shape having a central part thereof bulging upward. The diaphragm 7 may be formed of a thin plate of stainless steel or a laminated body including a stainless steel and a thin plate of nickel-cobalt alloy, and may have any shape.

The diaphragm pressing member 8 is arranged above the diaphragm 7, and is capable of pushing the central part of the diaphragm 7.

The stem 9 is supported by the bonnet 5 so as to be able to move vertically, and is configured to move toward and away from the diaphragm 7, to bring the diaphragm 7 into abutment with the sheet 4D and moving away the diaphragm 7 therefrom through the diaphragm pressing member 8. In this embodiment, the movement direction of the stem 9 corresponds to the vertical direction.

The piston 10 is configured integrally with the stem 9, and is arranged above the stem 9 to be supported by the bonnet 5 so as to be able to move vertically. The lower surface of the piston 10 and the upper surface of the bonnet 5 defines an operating fluid introduction chamber 10a. The piston 10 is formed with an operating fluid introduction passage 10b extending to the operating fluid introduction chamber 10a from an upper end thereof.

The first compression coil spring 11 is arranged between the lower surface of the upper portion 6A and the upper surface of the piston 10, and is configured to constantly urges the piston 10 downward.

A first O-ring 5A is arranged between the bonnet 5 and the stem 9, and is configured to guide the vertical movement of the stem 9 and the piston 10. A second O-ring 5B is arranged between the bonnet 5 and the piston 10, and is configured to guide the vertical movement of the stem 9 and the piston 10. The first O-ring 5A and the second O-ring 5B are configured to seal parts of the operating fluid introduction chamber 10a other than those communicating to the operating fluid introduction passage 10b.

Next, the valve mechanism 20 is described with reference to FIG. 1 to FIG. 5. In FIG. 1 and FIG. 2, the valve mechanism 20 is in the closed state. The valve mechanism 20 includes a first guiding portion 21, a knock portion 22, a rotator 23, a stopper 24, a second guiding portion 25, and a second compression coil spring 26. The valve mechanism 20 is provided on a casing configured by the bonnet 5 and the cap 6.

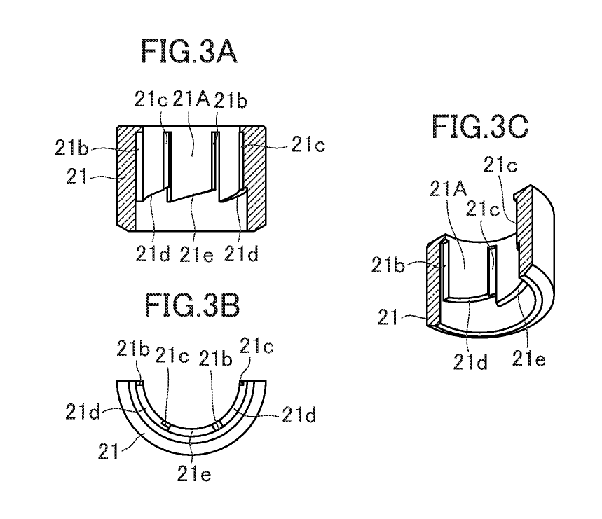

FIGS. 3A to 3C are explanatory diagrams of the first guiding portion 21, in which FIG. 3A is a longitudinal sectional view of the first guiding portion 21, FIG. 3B is a bottom view the first guiding portion 21 of illustrated in FIG. 3A, and FIG. 3C is a perspective sectional view of the first guiding portion 21.

The first guiding portion 21 has a substantially cylindrical shape, and is screwed in a first screw hole 6c1 of the cap 6. The inner surface of the whole circumference of the first guiding portion 21 is provided with a cam portion 21 projecting inward. The cam portion 21A is provided from the upper end to the central part of the first guiding portion 21. The cam portion 21A has a plurality of (three in this embodiment) first cam grooves 21b and a plurality of (three in this embodiment) second cam grooves 21c formed therein. The first cam grooves 21b and the second cam grooves 21c are alternately formed in the circumferential direction at equal intervals. The first cam grooves 21b are formed deeper than the second cam grooves 21c in the radial direction of the first guiding portion 21. The first cam grooves 21b and the second cam grooves 21c each have a closed upper end and a lower end opened downward.

The lower end of the cam portion 21A has a plurality of (three in this embodiment) first cam surfaces 21d and a plurality of (three in this embodiment) second cam surfaces 21e formed therein. The first cam surfaces 21d and the second cam surfaces 21e are inclined with respect to the vertical direction (the axial direction of the first guiding portion 21). The first cam surface 21d is formed so as to gradually rise from the lower end positioned at the opening of the first cam groove 21b toward the opening of the second cam groove 21c. The second cam surface 21e is formed so as to gradually rise from the lower end positioned below the opening of the second cam groove 21c toward the opening of the first cam groove 21b.

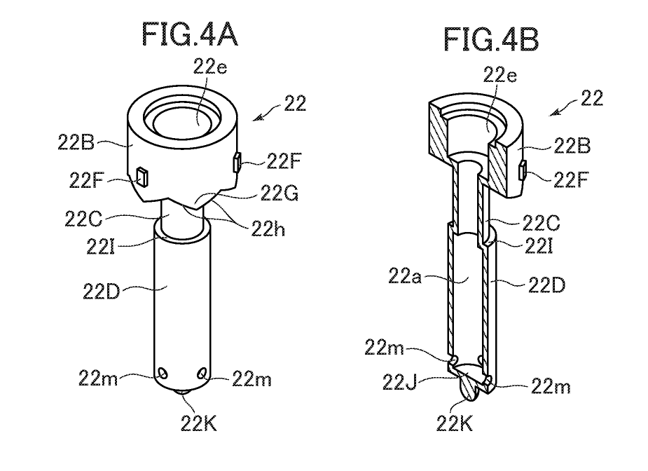

FIGS. 4A and 4B are explanatory diagrams of the knock portion 22, in which FIG. 4A is a perspective view of the knock portion 22, and FIG. 4B is a perspective sectional view of the knock portion 22.

The knock portion 22 has an operating fluid inflow passage 22a formed therein, and has a substantially cylindrical shape having a bottom. The knock portion 22 includes a joint screwing portion 22B corresponding to a pushing portion, a first operating fluid inflow portion 22C, and a second operating fluid inflow portion 22D. The joint screwing portion 22B has a female screw formed in an inner periphery 22e thereof. A male screw of a screwing portion 3A of the pipe joint 3 is screwed in this female screw to mount the pipe joint 3 on the knock portion 22.

The joint screwing portion 22B is arranged in the first guiding portion 21 so as to be able to move vertically. A plurality of (three in this embodiment) projecting portions 22F are provided on the outer circumference of the joint screwing portion 22B. The projecting portions 22F project outward, and are arranged in the circumferential direction at equal intervals. As illustrated in FIG. 2, the projecting portions 22F are inserted into the second cam grooves 21c so as to be able to move vertically. The lower end of the joint screwing portion 22B has a plurality of (six in this embodiment) chevron-shaped first cam projections 22G formed therein in a saw-blade-like form. The three projecting portions 22F are each arranged above a tip (vertex) of every other one of six first cam projections 22G Thus, the vertex (tip) of each chevron of the first cam projections 22G is arranged to oppose to the first cam grooves 21b and the second cam grooves 21c in the radial direction. Each of the first cam projections 22G are formed of two third cam surfaces 22h inclining with respect to the vertical direction.

The first operating fluid inflow portion 22C is arranged below the joint screwing portion 22B, and has a cylindrical shape. The first operating fluid inflow portion 22C has an outer diameter smaller than an outer diameter of the joint screwing portion 22B.

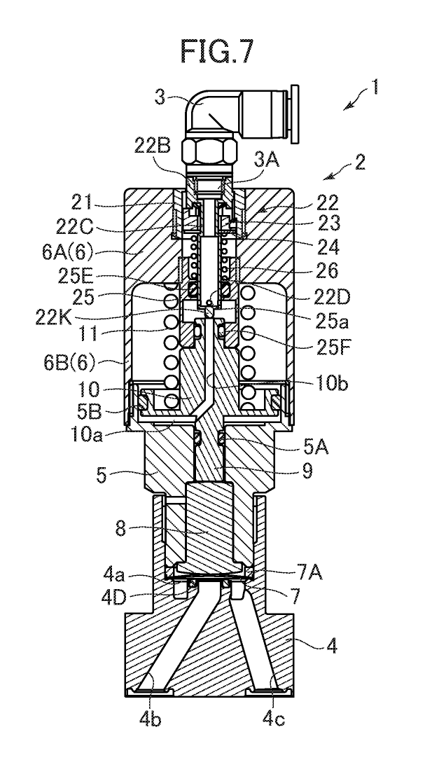

The second operating fluid inflow portion 22D is arranged below the first operating fluid inflow portion 22C, and has a substantially cylindrical shape. The second operating fluid inflow portion 22D has an outer diameter larger than the outer diameter of the first operating fluid inflow portion 22C. As a result, the first operating fluid inflow portion 22C and the second operating fluid inflow portion 22D form a step portion 221 corresponding to a stopper abutting portion. The lower end of the second operating fluid inflow portion 22D is closed by a disc portion 22J. The disc portion 22J includes a plug 22K corresponding to an opening and closing member. The plug 22K is a substantially cylindrical shape having a semispherical tip portion, and the outer diameter thereof is slightly smaller than the inner diameter of the operating fluid introduction passage 10b. The plug 22K is capable of entering the operating fluid introduction passage 10b and retreating therefrom. A plurality of (four in this embodiment) operating fluid outflow holes 22m are formed in the vicinity of the lower end of the second operating fluid inflow portion 22D. The closed position of the plug 22K is a state in which the plug 22K has entered the operating fluid introduction passage 10b as illustrated FIG. 2, and the open position of the plug 22K is a state in which the plug 22K has retreated from the operating fluid introduction passage 10b as illustrated in FIG. 7.

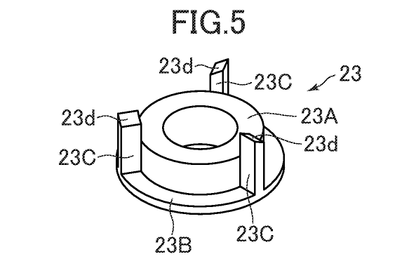

FIG. 5 is a perspective view of the rotator 23.

As illustrated in FIG. 5, the rotator 23 includes a cylinder portion 23A, a flange portion 23B, and a plurality of (three in this embodiment) second cam projections 23C. The inner diameter of the cylinder portion 23A is larger than the outer diameter of the first operating fluid inflow portion 22C. The flange portion 23B projects outward from the lower end of the cylinder portion 23A, and the outer diameter of the flange portion 23B is smaller than the inner diameter of the first guiding portion 21. The second cam projections 23C extend upward from the flange portion 23B, and are arranged in the circumferential direction at equal intervals. The tip of each of the second cam projections 23C has a fourth cam surface 23d inclined with respect to the vertical direction.

As illustrated in FIG. 2, the rotator 23 in which a knock portion 22 is inserted in a through hole thereof is arranged in the first guiding portion 21 so as to be rotatable and vertical movable with respect to the first guiding portion 21 on the lower side of the joint screwing portion 22B. The fourth cam surfaces 23d of the second cam projections 23C can be brought into abutment with the first cam surfaces 21d and the second cam surfaces 21e of the first guiding portion 21 and the third cam surfaces 22h of the joint screwing portion 22B. The outer end portions of the fourth cam surfaces 23d in the radial direction thereof are located on the outer side of the second cam grooves 21c of the first guiding portion 21. Thus, the second cam projections 23C are capable of entering the first cam grooves 21b and retreating therefrom, but are prevented from entering the second cam grooves 21c.

The stopper 24 has a disc shape having a slit formed therein. The slit of the stopper 24 has a width slightly larger than the outer diameter of the first operating fluid inflow portion 22C and smaller than the outer diameter of the second operating fluid inflow portion 22D. The first operating fluid inflow portion 22C is inserted into the slit of the stopper 24, and the stopper 24 is brought into abutment with the step portion 221, thereby preventing the movement to the second operating fluid inflow portion 22D side beyond the first operating fluid inflow portion 22C. The length obtained by adding the length of the rotator 23 in the vertical direction (the length from the flange portion 23B to the end portion of the second cam projection 23C) and the thickness of the stopper 24 is substantially equal to the length between the tip (vertex) of the first cam projection 22G in the vertical direction and the step portion 221.

As illustrated in FIG. 2, the second guiding portion 25 has a substantially cylindrical shape, and the upper end portion thereof is screwed in the second screw hole 6c2 of the cap 6. The second guiding portion 25 has a spring inserting hole 25a, an O-ring accommodating groove 25b, a fluid inflow groove 25c, and a piston inserting hole 25d formed therein.

The second compression coil spring 26 is inserted into the spring inserting hole 25a. The O-ring accommodating groove 25b is formed in succession on the entire inner periphery of the second guiding portion 25, and is configured to accommodate a third O-ring 25E. The third O-ring 25E is arranged between the second operating fluid inflow portion 22D of the knock portion 22 and the second guiding portion 25, and is configured to guide the movement of the knock portion 22 in the vertical direction, and to prevent the operating fluid from flowing above the compression coil spring 11.

The fluid inflow groove 25c is formed in succession on the entire inner periphery of the second guiding portion 25. The second operating fluid inflow portion 22D is arranged so that the fluid outflow holes 22m thereof are opened toward the fluid inflow groove 25c. As a result, the operating fluid flowing out of the fluid outflow holes 22m of the second operating fluid inflow portion 22D flows into the fluid inflow groove 25c.

The upper end portion of the piston 10 is inserted into the piston inserting hole 25d. A fourth O-ring 25F is arranged between the lower end portion of the second guiding portion 25 and the upper end portion of the piston 10, and is configured to prevent the operating fluid from leaking into the space accommodating the first compression coil spring 11.

The second compression coil spring 26 is inserted into the spring inserting hole 25a, and is arranged between the stopper 24 and the second guiding portion 25, to constantly bias the rotator 23 and the stopper 24 upward.

The pipe joint 3 is a one-touch joint, and has an L-shape. The pipe joint 3 is mounted on the knock portion 22 by screwing the screwing portion 3A of the pipe joint 3 in the joint screwing portion 22B of the knock portion 22. A tube extending from a supplying source of the operating fluid is inserted into the pipe joint 3.

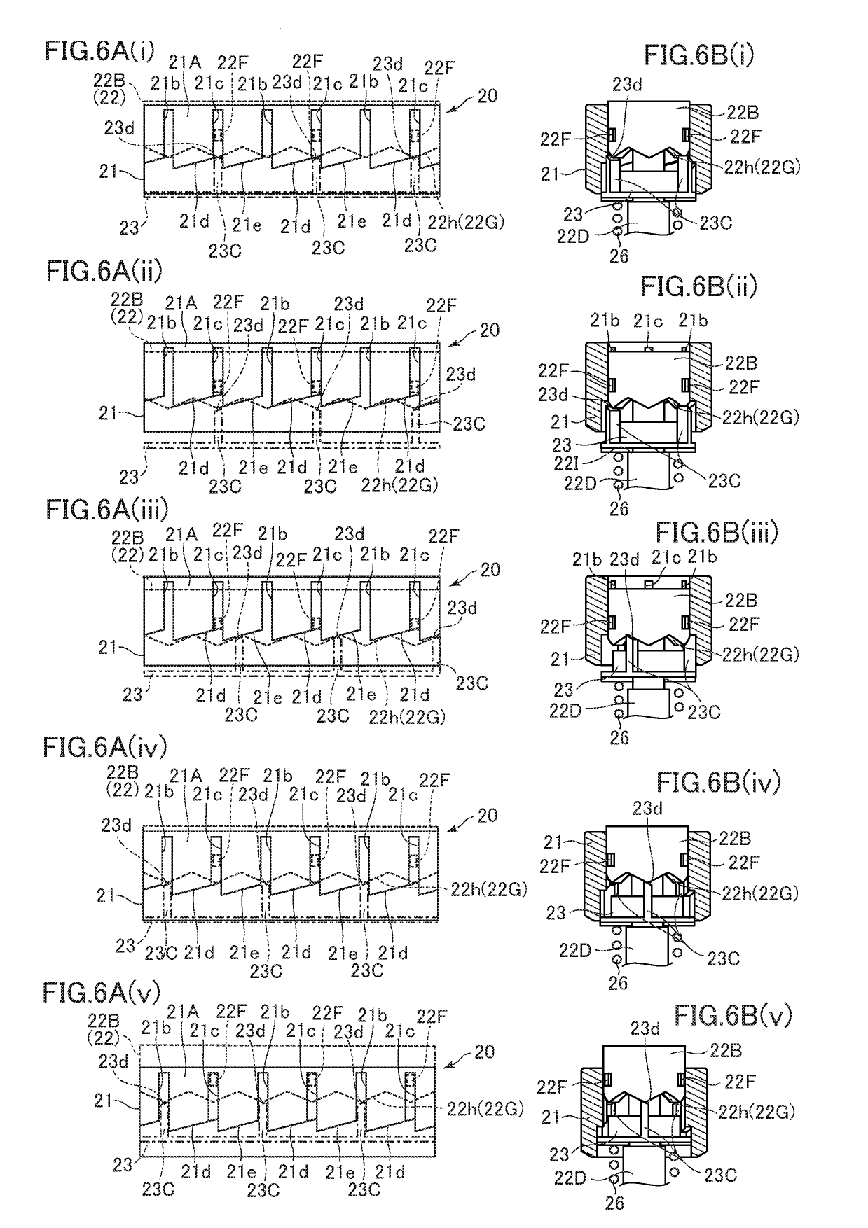

Next, the operation of the valve mechanism 20 is described with reference to FIGS. 6A(i) to 6A(v) and FIGS. 6B(i) to 6B(v).

FIGS. 6A(i) to 6A(v) and FIGS. 6B(i) to 6B(v) illustrate a transition of the operation of the valve mechanism 20. FIG. 6A(i) to FIG. 6A(v) illustrate development views of the first guiding portion 21, the knock portion 22, and the rotator 23, and FIG. 6B(i) to FIG. 6B(v) illustrate front views of the first guiding portion 21, the knock portion 22, and the rotator 23. In FIG. 6A(i) to FIG. 6A(v), the first guiding portion 21 is indicated by solid lines, the knock portion 22 is indicated by dotted lines, and the rotator 23 is indicated by alternate long and short dash lines. FIG. 6B(i) to FIG. 6B(v) illustrate sectional diagrams of the first guiding portion 21.

FIG. 6A(i) illustrates a positional relationship between the first guiding portion 21, the knock portion 22, and the rotator 23 of the valve mechanism 20 in the closed state. In this state, the fourth cam surface 23d of each of the second cam projections 23C is in abutment with the first cam surface 21d of the first guiding portion 21 and the third cam surface 22h of the joint screwing portion 22B below the second cam grooves 21c. As a result, the rotator 22 is unable to move upward from this position. The fourth cam surface 23d of the second cam projection 23C is in abutment with the tip portion (vertex) of the first cam projection 22G of the joint screwing portion 22B. The length obtained by adding the length of the rotator 23 in the vertical direction and the thickness of the stopper 24 is substantially equal to the length between the tip of the first cam projection 22G and the step portion 221 in the vertical direction, and thus the knock portion 22 is also unable to move upward from this position.

The state of the first guiding portion 21, the knock portion 22, and the rotator 23 illustrated in FIG. 6B(i) is similar to the state of the first guiding portion 21, the knock portion 22, and the rotator 23 illustrated in FIG. 2. Thus, as illustrated in FIG. 2, the plug 22K of the knock portion 22 has entered the fluid introduction passage 10b, and prevents the operating fluid from flowing into the fluid introduction passage 10b.

When a user pushes the pipe joint 3, as illustrated in FIG. 6A(ii) and FIG. 6B(ii), the knock portion 22, the rotator 23, and the stopper 24 sink down against the biasing force of the second compression coil spring 26. When the fourth cam surfaces 23d of the second cam projections 23C come below the second cam surfaces 21e of the cam portion 21A, the rotator 23 moves such that the fourth cam surfaces 23d of the second cam projections 23C move along the third cam surfaces 22h of the joint screwing portion 22B due to the biasing force of the second compression coil spring 26. As a result, the rotator 23 and the stopper 24 move upward along the third cam surfaces 22h.

FIG. 6A(iii) and FIG. 6B(iii) illustrate the state of the first guiding portion 21, the knock portion 22, and the rotator 23 when the disc portion 22J of the knock portion 22 is in abutment with the upper end of the piston 10. As illustrated in FIG. 6A(iii) and FIG. 6B(iii), the tip of each of the second cam projections 23C are positioned at a valley portion formed by adjacent first cam projections 22G.

When the user stops pushing the pipe joint 3, the rotator 23 and the joint screwing portion 22B of the knock portion 22 are pushed to move upward due to the biasing force of the second compression coil spring 26. As a result, the fourth cam surfaces 23d of the second cam projections 23C move along the first cam surfaces 21d of the cam portion 21A.

As illustrated in FIG. 6A(iv) and FIG. 6B(iv), when the second cam projections 23C move to a place below the first cam grooves 21b, the second cam projections 23C move upward along the first cam grooves 21b. As a result, the joint screwing portion 22B is pushed up.

Then, as illustrated in FIG. 6A(v) and FIG. 6B(v), when the projecting portions 22F reach the upper ends of the second cam grooves 21c, the raising of the knock portion 22 and the rotator 23 is stopped. As illustrated in FIG. 7, the plug 22K of the knock portion 22 has retreated from the operating fluid introduction passage 10b, and the valve mechanism 20 opens. As a result, the operating fluid passing through the operating fluid inflow passage 22a of the knock portion 22 to flow out of the operating fluid outflow hole 22m flows into the fluid introduction passage 10b.

Then, the operating fluid is introduced into the operating fluid introduction chamber 10a. The stem 9 and the piston 10 move from the bottom dead point to the top dead point against the biasing force of the first compression coil spring 11. The diaphragm pressing member 8 moves upward due to the elastic force of the diaphragm 7 and the pressure of the fluid, and the valve device 1 opens.

In order to close the valve mechanism 20 that is open, the user pushes the pipe joint 3, to sink down the knock portion 22, the rotator 23, and the stopper 24 against the biasing force of the second compression coil spring 26. As a result, the second cam projections 23C move along the third cam surfaces 22h and the first cam surfaces 21d, thereby rotating the rotator 23. Then, the rotator 23 is placed in a state illustrated in FIG. 6A(i) and FIG. 6B(i), and the valve mechanism 20 is closed.

In the valve device 1 of this embodiment, even if the valve mechanism 20 that is open is closed, the valve device 1 stays open. In order to close place the valve device 1, the supplying of the fluid to the valve device 1 needs to be stopped.

As described above, the valve device 1 of this embodiment includes the valve mechanism 20 which is provided at the casing (the bonnet 5 and the cap 6) and which is capable of opening and closing the passage of the operating fluid to a drive unit (piston 10, operating fluid introduction chamber 10a, operating fluid introduction passage 10b, and first compression coil spring 11). Therefore, by leaving the valve mechanism 20 closed, the operating fluid does not reach the drive unit even if the operating fluid is supplied due to an erroneous operation. Then, the valve device 1 does not open, and hence gas may be prevented from being unintentionally supplied to the semiconductor manufacturing apparatus or the like.

In the valve mechanism 20, the plug 22K moves from the open position to the closed position or from the closed position to the open position each time the user presses the joint screwing portion 22B. The operating fluid may be prevented from being unintentionally supplied to the drive unit because the user opens and closes the valve mechanism 20 by hand.

The valve mechanism 20 includes the operating fluid inflow passage 22a into which the operating fluid flows from the outside. The operating fluid inflow passage 22a communicates to the operating fluid introduction passage 10b. Thus, the valve mechanism 20 may have a function of causing the operating fluid to flow in addition to a feature of opening and closing the operating fluid introduction passage 10b. As a result, the entire configuration of the valve device 1 may be simplified. Further, the valve mechanism 20 may be protected from the outside because the valve mechanism 20 is arranged in the casing (the bonnet 5 and the cap 6).

The valve mechanism 20 is formed of the first guiding portion 21, the knock portion 22, the rotator 23, and the second compression coil spring 26, and is configured to open and close the operating fluid introduction passage 10b through knocking. Therefore, the operating fluid introduction passage 10b may be opened and closed with a simple configuration.

When the plug 22K is in the closed position, the stopper 24 is in abutment with the step portion 221 of the knock portion 22, to restrict the upward movement of the knock portion 22. Thus, when the valve mechanism 20 is closed, the knock portion 22 may be prevented from moving.

This invention is not limited to embodiment described above. Various addition, modification and the like may be made in the scope of this invention by those skilled in the art.

For example, in embodiment described above, the valve device 1 is described to have a configuration in which the pipe joint 3 side is arranged on the upper side and the body 2 is arranged on the lower side. However, the direction of the arrangement is not limited thereto and the arrangement may be made in the horizontal direction or may be made in the upside-down direction.

The pipe joint 3 has an L-shape, but may have a linear shape (I-shape). The joint screwing portion 22B is configured to have the joint 3 mounted thereon, but may be configured such that the air tube extending from the supplying source of the operating fluid is directly mountable thereon.

The operating fluid flows through the valve mechanism 20, and the pipe joint 3 is mounted on the valve mechanism 20, but the operating fluid may flow into the fluid inflow groove 25c of the second guiding portion 25 without flowing through the valve mechanism 20, and the valve mechanism 20 may only open and close the flow passage. In this configuration, a configuration of a general knock-type ballpoint pen may be applied to the valve mechanism 20. The outer diameter of the second operating fluid inflow portion 22D is formed larger than the outer diameter of the first operating fluid inflow portion 22C, to thereby form the step portion 221, and the stopper 24 is brought into abutment with the step portion 221. However, the second operating fluid inflow portion 22D and the first operating fluid inflow portion 22C may have a similar outer diameter, and a projecting portion projecting outward may be arranged at the position of the step portion 221.

The disc portion 22J and the plug 22K are integrally arranged on the tip of the cylinder portion of the second operating fluid inflow portion 22D. However, the disc portion 22J and the plug 22K may be separated from the cylinder portion of the second operating fluid inflow portion 22D as a separate body, a coil spring may be interposed between the cylinder portion of the second operating fluid inflow portion 22D, and the disc portion 22J and the plug 22K, to bias the disc portion 22J and the plug 22K toward the operating fluid introduction passage 10b by the coil spring.

The valve device 1 is the diaphragm valve device, but may be other valve devices as long as the valve device is a valve device driven by the operating fluid. The operating fluid may be gas or liquid. The valve mechanism 20 is arranged inside the casing, by may be arranged outside the casing (the bonnet 5 and the cap 6).

What is claimed is:

1. A valve device, comprising:
a body having a fluid passage formed therein;
a valve element configured to open and close the fluid passage;
a stem arranged to be configured to move toward and away from the valve element to cause the valve element to open and close the fluid passage;
an actuator having a casing coupled to the body and a drive unit arranged in the casing to drive the stem by an operating fluid supplied from outside; and
a valve mechanism provided at the casing and configured to open and close a passage of the operating fluid to the drive unit.

2. The valve device according to claim 1,
wherein the valve mechanism includes a pushing portion to be pressed by a user, and an opening and closing member configured to open and close the passage of the operating fluid, and
wherein the opening and closing member is configured to move from an open position, in which the passage of the operating fluid is open, to a closed position, in which the passage of the operating fluid is closed, or move from the closed position to the open position each time the pushing portion is pressed.

3. The valve device according to claim 2, wherein the valve mechanism includes an operating fluid inflow passage into which the operating fluid from outside flows and which communicates to the passage of the operating fluid.

4. The valve device according to claim 1, wherein the valve mechanism is arranged in the casing.

5. The valve device according to claim 1, wherein the valve mechanism includes:
a guiding portion that has a cylindrical shape, is fixed to the casing, and has a cam portion projecting inward arranged on an inner periphery thereof, the cam portion having a plurality of first cam grooves extending in an axial direction formed therein at equal intervals in a circumferential direction and having an end portion on the drive unit side on which a plurality of first cam surfaces and a plurality of second cam surfaces inclined with respect to the axial direction are alternately formed, a pair of the first cam surface and the second cam surface positioned between adjacent first cam grooves;
the pushing portion that is arranged in the guiding portion to be configured to move along the axial direction of the guiding portion and that has an end portion on the drive unit side on which a plurality of chevron-shaped first cam projections projecting to the drive unit side are arranged, each of the first cam projections including two third cam surfaces inclined with respect to the axial direction;
an operating fluid inflow portion that is coupled to the drive unit side of the pushing portion and that extends toward the drive unit;
the opening and closing member arranged on the drive unit side of the operating fluid inflow portion;
a rotator that has a ring-shape into which the operating fluid inflow portion is inserted, is arranged on the drive unit side of the pushing portion, and includes a second cam projection configured to enter the first cam groove and retreat from the first cam groove, the second cam projection projecting toward the pushing portion and having a fourth cam surface inclined with respect to the axial direction on a tip thereof, the fourth cam surface being configured to be in abutment with the first cam surface, the second cam surface, and the third cam surface; and
a coil spring configured to push the rotator to the pushing portion side,
wherein the pushing portion and the operating fluid inflow portion have the operating fluid inflow passage formed therein,
wherein, in a state in which the opening and closing member is in the open position, the second projection of the rotator enters the first cam groove, and the fourth cam surface is in abutment with the third cam surface of the pushing portion,
wherein, in a state in which the opening and closing member is in the closed position, the second projection of the rotator retreats from the first cam groove, and the fourth cam surface is in abutment with the first cam surface and the third cam surface,
wherein, when the opening and closing member is in the closed position, by pushing and releasing the pushing portion, the pushing portion and the rotator move to the drive unit side against a biasing force of the coil spring, and the fourth cam surface of the rotator moves along the second cam surface and the third cam surface, the second projection of the rotator enters the first cam groove by the biasing force of the coil spring, and the opening and closing member moves to the open position, and
wherein, when the opening and closing member is in the open position, by pushing and releasing the pushing portion, the pushing portion and the rotator move to the drive unit side against the biasing force of the coil spring, the second projecting portion of the rotator retreats from the first cam groove to move along the first cam surface and the third cam surface, and the opening and closing member moves to the closed position.

6. The valve device according to claim 5,
wherein the operating fluid inflow portion has a stopper abutting portion projecting outward,
wherein the valve mechanism further includes a stopper arranged on the drive unit side of the rotator to be configured to be in abutment with the stopper abutting portion, and
wherein, in a state in which the opening and closing member is in the closed position, the fourth cam surface of the second projection of the rotator is in abutment with the first cam surface of the guiding portion, the stopper is in abutment with the rotator, and the stopper abutting portion is in abutment with the stopper to restrict a movement of the pushing portion to a side opposite to the drive unit side.
